(19) United States
(12) Patent Application Publication
(10) Pub. No.: US 2023/0140475 A1
(43) Pub. Date: May 4, 2023

(54) METHOD FOR INFERRING INTENT OF MESSAGE

(71) Applicant: MISOINFO Tech., Seoul (KR)

(72) Inventors: Dong Uk An, Seoul (KR); Su-young Ho, Seoul (KR); Sang-do Nam, Seoul (KR); Jin-ho Son, Hanam-si (KR); Won-Hyeong Park, Seoul (KR); Cho-Rok Kim, Hwaseong-si (KR)

(21) Appl. No.: 17/979,671

(22) Filed: Nov. 2, 2022

(30) Foreign Application Priority Data
Nov. 2, 2021 (KR) 10-2021-0148423

(51) Int. Cl. G06F 40/35; H04L 51/02

(52) U.S. Cl. CPC G06F 40/35; H04L 51/02

(57) ABSTRACT

Disclosed is a method for inferring an intent of a message performed by a computing device including at least one processor according to some aspects of the present disclosure. The method for inferring an intent of a message includes: requesting chatbot application programming interface (API) connection information to a server upon receiving a request signal for inferring the intent of the message from a user terminal; inferring the intent of the message by calling a chatbot API determined based on the chatbot API connection information when receiving the chatbot API connection information from the server; and transmitting a result of inferring the intent of the message to the user terminal.

### CROSS REFERENCE TO RELATED APPLICATION

The present application claims priority to Korean Patent Application No. 10-2021-0148423, filed on Nov. 2, 2021, the entire contents of which is incorporated herein for all purposes by this reference.

### BACKGROUND

### 1. Field

One aspect of the present disclosure relates to a method for inferring an intent of a message, and more specifically, to a method for inferring an intent of a message using a chatbot.

### 2. Description of Related Art

Recently, virtual assistant services such as chatbots using artificial intelligence have been provided. The chatbot may be a service that infers and understands the intent of a person's question, and provides an answer phrase. In addition, the chatbot infers and understands the intent of a person's request, and may perform an action in response to the request.

For example, when the chatbot receives a message from a user requesting to order food, to reserve/change/cancel a medical treatment schedule, etc., the chatbot may infer the user's intent from the input message and perform a corresponding operation.

The chatbot may use a pre-trained network model to provide such a service. A conventional chatbot operates at the level of providing only a predetermined answer corresponding to a predetermined input according to a predetermined algorithm. Meanwhile, in the case of a chatbot provided recently, the accuracy of the chatbot is improved compared to the conventional one by inferring the intent of the message input from the user using a pre-trained network model. However, when a network model that is not properly trained is used, a problem of lowering accuracy than the conventional level may occur.

### RELATED ART DOCUMENTS

### Patent Documents

(Patent Document 0001) Korean Registered Patent No. 10-2215286

### SUMMARY

One aspect of the present disclosure has been devised in response to the above background art, and provides a method for inferring an intent of a message.

The technical objects of the present disclosure are not limited to the technical objects mentioned above, and other technical objects not mentioned will be clearly understood by those skilled in the art from the following description.

In order to achieve the above objects, one aspect of the present disclosure discloses a method of inferring an intent of a message performed by a computing device including at least one processor. The method for inferring an intent of a message may include: requesting chatbot application programming interface (API) connection information to a server upon receiving a request signal for inferring the intent of the message from a user terminal; inferring the intent of the message by calling a chatbot API determined based on the chatbot API connection information when receiving the chatbot API connection information from the server; and transmitting a result of inferring the intent of the message to the user terminal.

In addition, inferring the intent of the message by calling the chatbot API determined based on the chatbot API connection information may include: recognizing an entity name from the message by performing pre-processing on the message included in the request signal; and inferring the intent of the message by using a pre-trained intent inference model having the entity name as an input value.

In addition, recognizing the entity name from the message may include recognizing the entity name from the message according to a named entity recognition (NER) technique for recognizing the entity name from an unstructured text included in the message.

In addition, the pre-trained intent inference model may be trained using training data transformed from the unstructured text using the NER technique.

In addition, the chatbot API connection information may include at least one of an Internet protocol (IP) address, host address, or port information.

In addition, the chatbot API may include: a first chatbot API; and a second chatbot API that is further created based on a number of request signals for inferring the intent of the message.

In addition, the method may further include: receiving status information indicating a status of at least one chatbot API among a plurality of chatbot APIs from the server; and removing the at least one chatbot API based on the status information

In addition, a computing device may include: a communication unit configured to request chatbot application programming interface (API) connection information to a server upon receiving a request signal for inferring an intent of a message from a user terminal; and a processor configured to infer the intent of the message by calling a chatbot API determined based on the chatbot API connection information when receiving the chatbot API connection information from the server, wherein the communication unit may transmit a result of inferring the intent of the message to the user terminal.

In addition, a computer program stored in a computer-readable storage medium may be provided, wherein the computer program is configured to perform a method for inferring an intent of a message when executed by at least one processor, and the method includes: requesting chatbot application programming interface (API) connection information to a server upon receiving a request signal for inferring the intent of the message from a user terminal; inferring the intent of the message by calling a chatbot API determined based on the chatbot API connection information when receiving the chatbot API connection information from the server; and transmitting a result of inferring the intent of the message to the user terminal.

In addition, a method for inferring an intent of a message performed by a server including at least one processor may include: inferring the intent of the message by calling a chatbot application programming interface (API) determined based on chatbot API connection information upon receiving a request signal for inferring the intent of the message from a user terminal; and transmitting a result of inferring the intent of the message to the user terminal.

In addition, a server may include: a server storage unit configured to store chatbot application programming interface (API) connection information; a server communication unit configured to receive a request signal for inferring an intent of a message from a user terminal; and a server processor configured to infer the intent of the message by calling a chatbot API determined based on the chatbot API connection information stored in the storage unit upon receiving the request signal for inferring the intent of the message from the server, wherein the server communication unit may transmit a result of inferring the intent of the message to the user terminal.

In addition, a computer program stored in a computer-readable storage medium may be provided, wherein the computer program is configured to perform a method for inferring an intent of a message when executed by at least one server processor, and the method includes: inferring the intent of the message by calling a chatbot application programming interface (API) determined based on chatbot API connection information upon receiving a request signal for inferring the intent of the message from a user server; and transmitting a result of inferring the intent of the message to the user terminal.

The technical solutions obtainable in the present disclosure are not limited to the above-mentioned technical solutions, and other technical solutions not mentioned will be clearly understood by those skilled in the art to which the present disclosure belongs from the description below.

According to some aspects of the present disclosure, it is possible to provide a method for improving accuracy in inferring the intent of a message.

The effects obtainable in the present disclosure are not limited to the above-mentioned effects, and other effects not mentioned will be clearly understood by those skilled in the art to which the present disclosure belongs from the description below.

### BRIEF DESCRIPTION OF DRAWINGS

Various aspects are now described with reference to the drawings, wherein like reference numerals are used to refer to like elements collectively. In the following aspects, for the purpose of explanation, numerous specific details are set forth in order to provide a thorough understanding of one or more aspects. However, it will be appreciated that such aspect(s) may be practiced without the specific details. In other examples, well-known structures and devices are shown in the form of block diagrams in order to facilitate the description of one or more aspects.

FIG. 1 illustrates an example system for performing a method for inferring an intent of a message according to some aspects of the present disclosure.

FIG. 2 is a flowchart illustrating an example of a method for inferring an intent of a message according to some aspects of the present disclosure.

FIG. 3 is a flowchart illustrating an example of a method for inferring an intent of a message using a computing device according to some aspects of the present disclosure.

FIG. 4 is a flowchart illustrating an example of a method for removing at least one chatbot API using a computing device according to some aspects of the present disclosure.

FIG. 5 illustrates an example system for performing a method for inferring an intent of a message according to some aspects of the present disclosure.

FIG. 6 illustrates a general schematic diagram of an example computing environment in which aspects of the present disclosure may be implemented.

### DETAILED DESCRIPTION

Various embodiments and/or aspects are now disclosed with reference to the drawings. In the following description, for the purposes of explanation, numerous specific details are set forth to provide a thorough understanding of one or more aspects. However, it will also be appreciated by those skilled in the art that such aspect(s) may be practiced without these specific details. The following description and accompanying drawings set forth in detail certain illustrative aspects of one or more aspects. However, these aspects are illustrative, and some of the various methods in principles of various aspects may be employed, and the descriptions set forth are intended to include all such aspects and their equivalents. Specifically, as used herein, “embodiment”, “example”, “aspect”, and “illustration” may not be construed as any described aspects or designs are better or advantageous over other aspects or designs. Hereinafter, the same reference numerals will be assigned to the same or similar components throughout all drawings, and redundant description thereof will be omitted. In addition, in describing the aspects disclosed in the present specification, if it is determined that detailed descriptions of related known technologies may obscure the subject matter of the aspects disclosed in the present specification, the detailed description thereof will be omitted. In addition, the accompanying drawings are only for easy understanding of the aspects disclosed in the present specification, and the technical ideas disclosed in the present specification are not limited by the accompanying drawings.

Although the first, second, etc. can be used to describe various elements or components, these elements or components are not limited by these terms. These terms are only used to distinguish one element or component from the other element or component. Therefore, the first element or component mentioned below may be the second element or component within the spirit of the present disclosure.

Unless otherwise defined, all terms (including technical and scientific terms) used herein may be used with the meaning commonly understood by those skilled in the art to which the present disclosure belongs. In addition, terms defined in a commonly used dictionary are not to be interpreted ideally or excessively unless clearly specifically defined.

In addition, the term “or” is intended to mean inclusive “or”, not exclusive “or”. In other words, unless otherwise specified or if unclear in context, the expression “X uses A or B” is intended to mean one of the natural inclusive substitutions. In other words, when X uses A; X uses B; or X uses both A and B, the expression “X uses A or B” can be applied to either of these cases. It is also to be understood that the term “and/or” used herein refers to and includes all possible combinations of one or more of the listed related items.

In addition, the terms “comprises” and/or “comprising” indicate the presence of corresponding features and/or elements, but do not exclude the presence or addition of one or more other features, components, and/or groups thereof. Further, unless otherwise specified or unless it is clear from the context to refer to a singular form, the singular in the specification and claims may generally be construed to refer to “one or more”.

In addition, as used herein, the terms “information” and “data” may often be used interchangeably.

When one element is described as being “connected” or “accessed” to another element, it may be understood that the element may be directly connected or accessed to the other element or may possibly have another element in between. Meanwhile, when one element is described as being “directly connected” or “directly accessed” to another element, it may be understood that no other element exists therebetween.

The suffixes “module” and “unit” for elements used in the following description are given in consideration of ease in preparing the present specification only, and do not have a particularly important meaning or role in themselves. Objects and effects of the present disclosure, and technical configurations for achieving them will become clear with reference to the aspects described below in detail in conjunction with the accompanying drawings. In describing the present disclosure, if it is determined that a detailed description of a well-known function or configuration may unnecessarily obscure the subject matter of the present disclosure, the detailed description thereof will be omitted. In addition, the terms described below are terms defined in consideration of functions in the present disclosure, which may vary according to the intent or custom of the user or operator.

However, the present disclosure is not limited to the aspects disclosed below and may be implemented in various different forms. The aspects of the present disclosure are provided only to complete the present disclosure, and to fully inform those skilled in the art to which the present disclosure belongs the scope of the disclosure, and the present disclosure is only defined by the scope of the claims. Therefore, the definition is made based on the content throughout the specification.

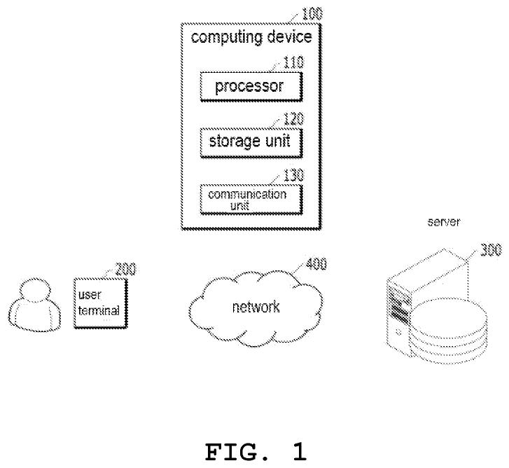

In the present disclosure, the computing device may infer the intent of the message according to the request received from the user terminal. Specifically, the computing device may call a chatbot application programming interface (API) to infer the intent of the message. The API may be an interface created to control the functionality provided by an operating system or programming language. The chatbot API may infer an intent from an input message through a pre-trained intent inference model, and may return the inferred result value to the computing device. Then, the computing device may transmit the inferred result value to the user terminal. Hereinafter, a method for inferring an intent of a message using a computing device according to the present disclosure will be described with reference to FIGS. 1 to 6.

FIG. 1 illustrates an example system for performing a method for inferring an intent of a message according to some aspects of the present disclosure.

Referring to FIG. 1, a system for inferring an intent of a message may include a computing device 100, a user terminal 200, a server 300, and a network 400. However, the above-described components are not essential in implementing a system for inferring the intent of the message, so the system for inferring the intent of the message may have more or fewer components than those listed above.

For example, the computing device 100 may include any type of computer systems or computer devices such as a microprocessor, a mainframe computer, a digital processor, a portable device or device controller, and the like.

Typically, the processor 110 may process the overall operation of the computing device 100. The processor 110 may process signals, data, information, etc. input or output through the components included in the computing device 100 or drive an application program stored in a storage unit 120, thereby providing appropriate information or functions to the user.

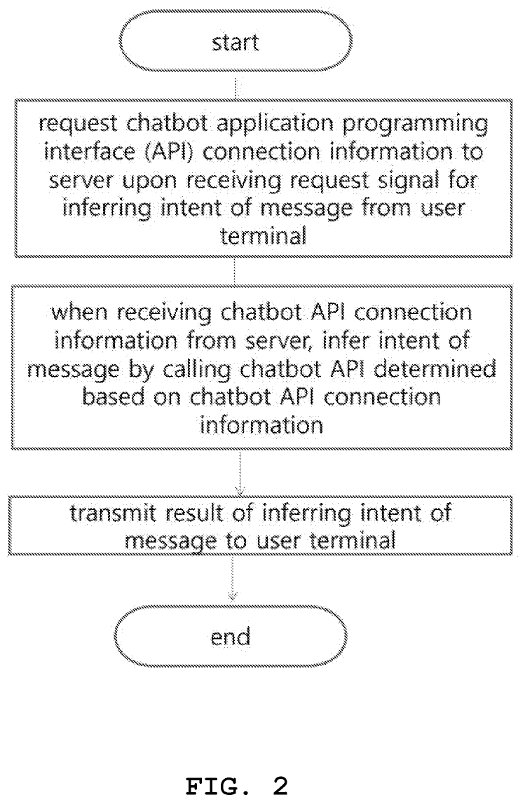

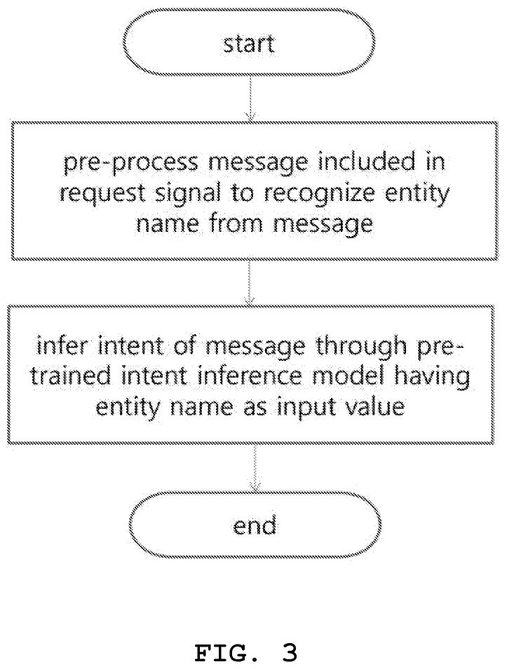

In the present disclosure, the processor 110 may request chatbot application programming interface (API) connection information to the server 300 upon receiving a request signal for inferring the intent of the message from the user terminal 200. The chatbot API may be an interface that is made to control functions provided by the operating system or programming language. As an example, the chatbot API may infer the intent of the message input by the user through a pre-trained intent inference model. The chatbot API connection information may refer to information allowing the processor 110 to call the chatbot API. According to one aspect of the present disclosure, the chatbot API connection information may include at least one of an Internet Protocol (IP) address, a host address, and port information. The processor 110 may infer the intent of the message included in the request signal by calling the chatbot API determined based on the chatbot API connection information. Hereinafter, the chatbot API will be described with reference to FIGS. 2 and 3.

According to some aspects of the present disclosure, the computing device 100 and the chatbot API may be implemented as separate entities.

The storage unit 120 may include a memory and/or a permanent storage medium. The memory may include at least one type of storage media including a flash type memory, a hard disk type memory, a multimedia card micro type memory, a card type memory (for example, SD or XD memory, etc.), a random access memory (RAM). a static random access memory (SRAM), a read-only memory (ROM), an electrically erasable programmable read-only memory (EEPROM), a programmable read-only memory (PROM), a magnetic memory, a magnetic disk, and an optical disk.

The communication unit 130 may include at least one module that enables communication between the computing device 100 and the communication system, between the computing device 100 and the user terminal 200, between the computing device 100 and the server 300, or between the computing device 100 and the network 400. The communication unit 130 may include at least one of a mobile communication module, a wired Internet module, and a wireless Internet module.

The user terminal 200 may include a personal computer (PC), a notebook, a mobile terminal, a smart phone, a tablet PC, etc. owned by the user, and may include all types of terminals capable of accessing a wired/wireless network.

In the present disclosure, the user terminal 200 may receive a message requesting to perform a service from the user. The user terminal 200 may receive a result of inferring the intent of the message by transmitting a request signal for inferring the intent of the message to the computing device 100. As the result is received, the user terminal 200 may perform an operation corresponding to the result or display a message corresponding to the result.

According to some aspects of the present disclosure, the computing device 100 and the user terminal 200 may be implemented as one entity.

For example, the server 300 may include any type of computer systems or computer devices such as microprocessors, mainframe computers, digital processors, portable devices and device controllers, and the like.

According to some aspects of the present disclosure, the server 300 may store chatbot API connection information. As an example, the chatbot API can be expanded dynamically. The expression ‘dynamically expanding’ may mean that it is automatically created/added without the intervention of an administrator. For example, the chatbot API may be further created based on a number of request signals for inferring the intent of the message. The additionally created chatbot API may transmit the API connection information to the server 300. Accordingly, the server 300 may store connection information for each of all chatbot APIs. Thus, the server 300 may transmit the chatbot API connection information in response to a signal requesting the chatbot API connection information received from the computing device 100.

According to some aspects of the present disclosure, the computing device 100 and the server 300 may be implemented as one entity. Accordingly, the computing device 100, the server 300, and the chatbot API may be implemented as one entity. For example, the computing device 100 may be included in the server 300 to operate as one entity. As another example, the computing device 100 and the chatbot API may be included in the server 300 to operate as one entity.

The network 400 may be configured regardless of a communication mode, such as a wired communication mode and a wireless communication mode, and may include various communication networks such as a personal area network (PAN) and a wide area network (WAN). In addition, the network may be a well-known world wide web (WWW), and may use a wireless transmission technique used for short-range communication, such as infrared data association (IrDA) or Bluetooth.

The techniques described herein may be used in other networks as well as in the networks mentioned above.

FIG. 2 is a flowchart illustrating an example of a method for inferring an intent of a message according to some aspects of the present disclosure.

Referring to FIG. 2, the communication unit 130 of the computing device 100 may request the chatbot application programming interface (API) connection information to the server 300 upon receiving the request signal for inferring the intent of the message from the user terminal 200 (S110).

The chatbot API connection information may be information allowing the processor 110 to call the chatbot API. According to an aspect, the chatbot API connection information may include at least one of an Internet Protocol (IP) address, a host address, and port information.

When receiving the chatbot API connection information from the server 300, the processor 110 may infer the intent of the message by calling the chatbot API determined based on the chatbot API connection information (S120).

Specifically, the processor 110 may recognize the entity name by calling the chatbot API and performing pre-processing on the message included in the request signal. For example, the processor 110 may recognize the entity name of “type of pizza” from the message “order a potato pizza” input from the user. In other words, the processor 110 may recognize the entity name of the text “potato pizza” as “pizza type”. As another example, the processor 110 may recognize the entity names of “pizza type” and “pizza size” from the message “order a large bulgogi pizza” input from the user. In other words, the processor 110 may recognize the entity name of the text “bulgogi pizza” as “pizza type” and recognize the entity name of the text “large” as “pizza size”. When the entity name is recognized, the processor 110 may infer the intent of the message through a pre-trained intent inference model having the entity name as an input value. Hereinafter, a method for inferring the intent of the message by calling the chatbot API using the processor 110 will be described in more detail with reference to FIG. 3.

According to some aspects of the present disclosure, the above-described operation may be performed through a voicebot API. The voicebot API may refer to a bot that recognizes a voice input from a user. According to an aspect, the computing device 100 and the user terminal 200 may be implemented as one entity. In this case, the computing device 100 may infer the intent of the voice message input from the user by calling the voicebot API.

According to some aspects of the present disclosure, the chatbot API may be dynamically expanded. As an example, the chatbot API may include a first chatbot API and a second chatbot API that is additionally created based on a number of request signals for inferring the intent of the message. In other words, the chatbot API may be dynamically expanded in proportion to the number of request signals to infer the intent of the message. The additionally created second chatbot API may transmit second chatbot API connection information to the server 300. Accordingly, the server 300 may store connection information of each of the plurality of chatbot APIs, and provide appropriate chatbot API connection information in response to a signal requesting the chatbot API connection information received from the computing device 100. For example, the computing device 100 may receive chatbot API connection information with no current job or the smallest queue among the plurality of chatbot APIs. Accordingly, the computing device 100 may quickly infer the intent of the message by calling the chatbot API determined based on the chatbot API connection information.

The communication unit 130 may transmit a result of inferring the intent of the message to the user terminal 200 (S130). According to an aspect, the computing device 100 may output a result of inferring the intent of the message to the user through a display unit.

According to the above-described configuration, the computing device 100 may request chatbot API connection information from the server 300 upon receiving a request signal for inferring the intent of the message from the user terminal 200. The computing device 100 may quickly infer the intent of the message included in the request signal received from the user terminal 200 by calling the chatbot API determined based on the chatbot API connection information.

Meanwhile, according to some aspects of the present disclosure, the computing device 100 may infer the intent by pre-processing the message. Hereinafter, an example of a method for inferring the intent of the message by using the computing device 100 according to the present disclosure will be described.

FIG. 3 is a flowchart illustrating an example of a method for inferring the intent of the message by using the computing device according to some aspects of the present disclosure.

Referring to FIG. 3, the processor 110 of the computing device 100 may pre-process the message included in the request signal to recognize the entity name (S121).

Specifically, the processor 110 may recognize the entity name by calling the chatbot API and performing the pre-processing on the message.

For example, the processor 110 may recognize the entity name from the message according to a named entity recognition (NER) technique for recognizing the entity name from the unstructured text included in the message. The NER may refer to a technique for recognizing a named entity, and may be a network model according to an aspect.

For example, the processor 110 may recognize the entity name of “type of pizza” from the message “order a potato pizza” input from the user.

The processor 110 may infer the intent of the message through a pre-trained intent inference model having the entity name as an input value (S122).

Specifically, the processor 110 may infer the intent of the message by using a pre-trained intent inference model having the entity name as an input value through the called chatbot API.

For example, the processor 110 may infer the intent of the user as the user intends to order a pizza type through the pre-trained intent inference model by using the entity name of “pizza type”, which is recognized from the message “order a potato pizza”, as an input value.

The intent inference model may include convolutional neural networks (CNNs), recurrent neural networks (RNNs), auto encoders, generative adversarial networks (GANs), restricted Boltzmann machines (RBMs), deep belief networks (DBNs), Q networks, U networks, Siamese networks, generative adversarial network (GANs) and the like. However, the above-described network models are merely an example, and the present disclosure is not limited thereto.

According to some aspects of the present disclosure, the pre-trained intent inference model may be trained using training data obtained by transforming the unstructured text using the NER technique. As the intent inference model is trained by using the training data transformed using the NER technique, the accuracy of the result value may be improved. The fact that the accuracy of the result value can be improved as the intent inference model is trained using the training data transformed using the NER technique has been proved as shown in Tables 1 and 2 below.

TABLE 1

| | | | Proba- | | Proba- |
|---|---|---|---|---|---|
| | | Result | bility | Result | bility |
| Example | Intent | (NER ∘) | (NER ∘) | (NER x) | (NER x) |
| Would you | pizza | pizza | 0.99 | pizza | 0.99 |
| like | order | order | | order | |
| medium | | | | | |
| shrimp | | | | | |
| pizza? | | | | | |
| Would you | pizza | pizza | 0.99 | pizza | 0.99 |
| likelarge | order | order | | order | |
| potato | | | | | |
| pizza? | | | | | |
| Please | pizza | pizza | 0.99 | pizza | 0.95 |
| order | order | order | | order | |
| pepperoni | | | | | |
| pizza | | | | | |
| Please | coffee | coffee | 0.92 | coffee | 0.34 |
| order a | order | order | | order | |
| cup of | | | | | |
| coffee | | | | | |
| Please | coffee | coffee | 0.99 | coffee | 0.34 |
| order ade | order | order | | order | |
| I want | coffee | coffee | 0.99 | coffee | 0.99 |
| vanilla | order | order | | order | |
| latte | | | | | |
| Please | hamburger | hamburger | 0.99 | hamburger | 0.99 |
| order two | order | order | | order | |
| cheese- | | | | | |
| burgers. | | | | | |
| Please | hamburger | hamburger | 0.99 | hamburger | 0.99 |
| order | order | order | | order | |
| bulgogi | | | | | |
| burger | | | | | |
| I want | hamburger | hamburger | 0.99 | hamburger | 0.99 |
| chicken | order | order | | order | |
| burger | | | | | |

Table 1 may be a comparison result between a case in which the first intent inference model is trained using training data transformed through the NER technique and a case in which the first intent inference model is trained using non-transformed training data. The first intent inference model may be a model using a word convolutional neural network (CNN).

Referring to Table 1, when the first intent inference model is trained using the training data transformed through the NER technique, the probability of inferring that the message “please order pepperoni pizza” intends to order pizza may be 0.99. Meanwhile, when the first intent inference model is trained using unmodified training data, the probability of inferring that the message “please order pepperoni pizza” is intended to order pizza may be 0.95.

Moreover, when the first intent inference model is trained using the training data transformed through the NER technique, the probability of inferring that the message “please order a cup of coffee” intends to order coffee may be 0.92. Meanwhile, when the first intent inference model is trained using unmodified training data, the probability of inferring that the message “please order a cup of coffee” intends to order coffee may be 0.34.

TABLE 2

| | | | Proba- | | Proba- |
|---|---|---|---|---|---|
| | | Result | bility | Result | bility |
| Example | Intent | (NER ∘) | (NER ∘) | (NER x) | (NER x) |
| Would you | pizza | pizza | 0.73 | hamburger | 0.55 |
| like | order | order | | order | |
| medium | | | | | |
| shrimp | | | | | |
| pizza? | | | | | |
| Would you | pizza | pizza | 0.69 | pizza | 0.46 |
| like large | order | order | | order | |
| potato | | | | | |
| pizza? | | | | | |
| Please | pizza | pizza | 0.40 | coffee | 0.39 |
| order | order | order | | order | |
| pepperoni | | | | | |
| pizza | | | | | |
| Please | coffee | coffee | 0.87 | pizza | 0.46 |
| order a | order | order | | order | |
| cup of | | | | | |
| coffee | | | | | |
| Please | coffee | coffee | 0.88 | coffee | 0.42 |
| order ade | order | order | | order | |
| I want | coffee | coffee | 0.88 | coffee | 0.37 |
| vanilla | order | order | | order | |
| latte | | | | | |
| Please | hamburger | hamburger | 0.84 | hamburger | 0.70 |
| order two | order | order | | order | |
| cheese- | | | | | |
| burgers. | | | | | |
| Please | hamburger | hamburger | 0.87 | hamburger | 0.74 |
| order | order | order | | order | |
| bulgogi | | | | | |
| burger | | | | | |
| I want | hamburger | hamburger | 0.88 | pizza | 0.39 |
| chicken | order | order | | order | |
| burger | | | | | |

Table 2 may be a comparison result between a case in which the second intent inference model is trained using the training data transformed through the NER technique and a case in which the second intent inference model is trained using the unmodified training data. The second intent inference model may be a model using bidirectional encoder representations from transformers (Bert).

Referring to Table 2, when the second intent inference model is trained using the training data transformed through the NER technique, the probability of inferring that the message “would you like medium shrimp pizza?” intends to order pizza is 0.73. Meanwhile, when the second intent inference model is trained using unmodified training data, the probability of inferring that the message “would you like medium shrimp pizza?” intends to order pizza may be 0.55.

As demonstrated through Tables 1 and 2, when the intent inference model is trained using the training data transformed using the NER technique, the accuracy of the result value may be improved than a case in which it is trained using the unmodified training data.

Meanwhile, According to some aspects of the present disclosure, the computing device 100 may remove at least one chatbot API among a plurality of chatbot APIs. Hereinafter, an example of a method for removing at least one chatbot API by using the computing device 100 will be described.

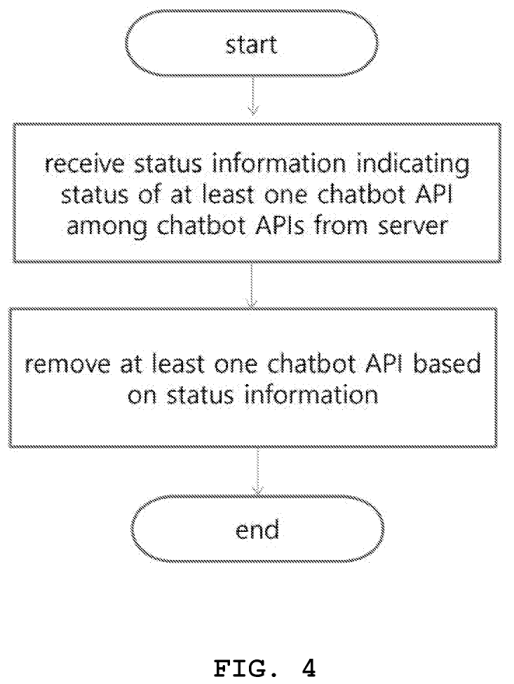

FIG. 4 is a flowchart illustrating an example of a method for removing at least one chatbot API by using the computing device according to some aspects of the present disclosure.

Referring to FIG. 4, the communication unit 130 of the computing device 100 may receive status information indicating the status of at least one chatbot API among a plurality of chatbot APIs from the server 300 (S210). The status information may refer to information indicating whether the chatbot API is in a normal status or an abnormal status.

Specifically, each of the plurality of chatbot APIs may receive a signal for checking the status at a preset interval from the server 300. At least one chatbot API among the plurality of chatbot APIs may return a signal for indicating a status in response to the received signal. In this case, the server 300 may determine that at least one chatbot API that has not received the return signal is in an abnormal status.

For example, each of the first chatbot API and the second chatbot API may receive a signal for checking the status from the server 300 at a preset interval. The first chatbot API may return a signal that indicates the status in response to the received signal. The second chatbot API may not return a signal that indicates the status in response to the received signal. Alternatively, the second chatbot API may not receive a signal transmitted at a preset interval from the server 300. Otherwise, the second chatbot API may return information that indicates an abnormal status in response to the received signal. In this case, the server 300 may generate status information which determines that the second chatbot API is in an abnormal status.

The processor 110 may remove at least one chatbot API based on the status information (S220).

As described above, the status of each chatbot API may be managed by the server 300. Since the chatbot API can be dynamically expanded, a load may be applied to the computing device 100 or an administrator when managing the chatbot APIs one by one. For this reason, the computing device 100 may efficiently manage resources by performing only an operation of removing at least one chatbot API based on the status information received from the server 300.

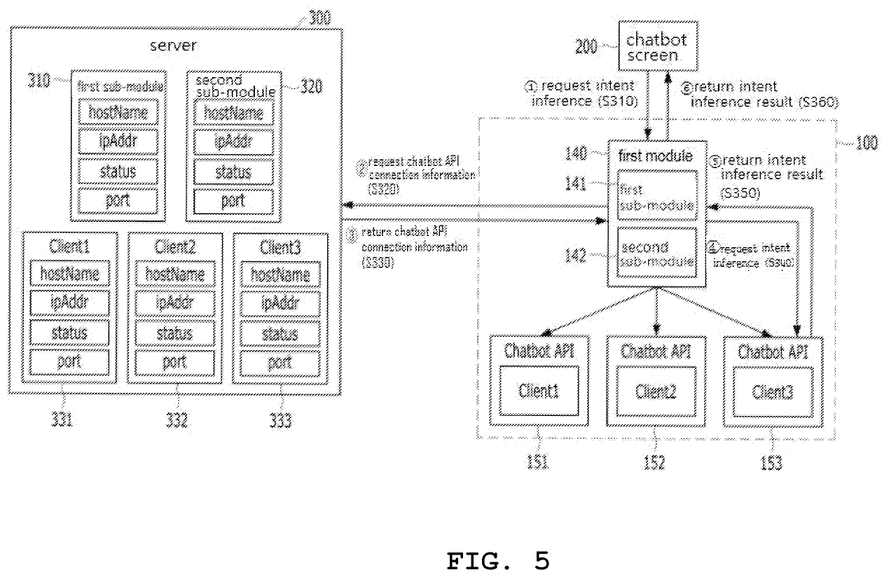

FIG. 5 illustrates an example system for performing a method for inferring an intent of a message according to some aspects of the present disclosure.

Referring to FIG. 5, the computing device 100 may receive a signal requesting the intent inference from the user terminal 200 (S310).

The computing device 100 may include a first module 140 and at least one chatbot API 151, 152, and 153. The first module 140 may refer to a module such as Zuul, which is an API gateway for proxying or routing a request signal received from the user terminal 200 to an appropriate service. According to an aspect, the first module 140 may receive a request signal for inferring the intent of the message from the user terminal 200.

In the present disclosure, the first module 140 may include a first sub-module 141 and a second sub-module 142.

The first sub-module 141 may refer to a module such as Ribbon that distributes traffic to several servers to prevent service load. According to an aspect, the first sub-module 141 may distribute the message included in the request signal received from the user terminal 200 to the chatbot API determined based on the chatbot API connection information.

The second sub-module 142 may refer to a module such as Hystrix that stops communication when a problem occurs in a specific service and connects communication when the status of the corresponding service returns to the normal status. According to an aspect, the second sub-module 142 may remove at least one chatbot API 151, 152 and 153 based on the status information received from the server 300.

The first module 140 may request the chatbot API connection information to the server 300 (S320). The server 300 may return the chatbot API connection information in response to the request received from the first module 140 (S330).

The server 300 may store information 310 related to the first sub-module, information 320 related to the second sub-module, and at least one chatbot API connection information 331, 332 and 333. According to an aspect, the server 300 may store at least one of the transmitted IP address, host address, and port information related to the first sub-module 141. The server 300 may store at least one of the transmitted IP address, host address, and port information related to the second sub-module 142. The server 300 may store at least one of IP address, host address, and port information transmitted by at least one chatbot API 151, 152, and 153.

The first module 140 may request the intent inference by calling the chatbot API determined based on the chatbot API connection information returned from the server 300 (S340), and may receive a result of inferring the intent of the message returned from the chatbot API (S350).

The first module 140 may transmit a result of inferring the intent of the message returned from the chatbot API to the user terminal 200 (S360).

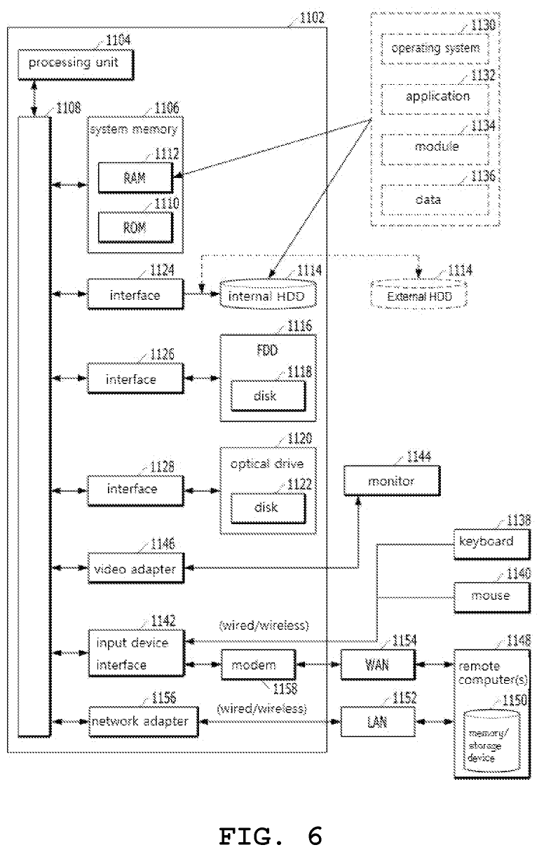

FIG. 6 illustrates a general schematic diagram of an example computing environment in which aspects of the present disclosure may be implemented.

Although the present disclosure has been described above generally in the context of computer-executable instructions that may be executed on at least one computer, those skilled in the art will appreciate that the present disclosure may be implemented as a combination of hardware and software and/or in combination with other program modules.

In general, modules herein include routines, procedures, programs, components, data structures, etc. that may perform specific tasks or implement specific abstract data types. In addition, those skilled in the art will appreciate that the methods of the present disclosure can be implemented not only with single-processor or multiprocessor computer systems, minicomputers, and mainframe computers, but also with other computer system configurations including personal computers, handheld computing devices, microprocessor-based or programmable consumer electronics, etc. (each of which can be operated in connection with one or more associated devices).

The aspects described in the present disclosure may also be practiced in distributed computing environments where certain tasks are performed by remote processing units that are linked through a communications network. In a distributed computing environment, program modules may be located in both local and remote memory storage devices.

Computers typically include a variety of computer-readable media. Media accessible by a computer include volatile and nonvolatile media, transitory and non-transitory media, removable and non-removable media. By way of an example, but not limited thereto, computer-readable media may include computer-readable storage media and computer-readable transmission media.

Computer-readable storage media include volatile and non-volatile media, temporary and non-transitory media, removable and non-removable media implemented in any method or technology for storing information such as computer readable instructions, data structures, program modules or other data. Computer-readable storage media may include, but not limited thereto, RAMs, ROMs, EEPROMs, flash memory or other memory technologies, CD-ROMs, digital video disks (DVDs) or other optical disk storage devices, magnetic cassettes, magnetic tapes, magnetic disk storage devices or other magnetic storage devices, or any other media that can be accessed by a computer and used to store desired information.

Computer readable transmission media typically implement computer readable instructions, data structures, program modules or other data in a modulated data signal such as a carrier wave or other transport mechanism, and include any information delivery medium. The term ‘modulated data signal’ refers to a signal in which one or more of the characteristics of the signal are set or changed so as to encode information in the signal. By way of an example, but not limited thereto, computer-readable transmission media include wired media such as a wired network or direct-wired connection, and wireless media such as acoustic, RF, infrared, and other wireless media. Combinations of any of the above are also intended to be included within the scope of computer-readable transmission media.

An example environment 1100 including a computer 1102 for implementing various aspects of the disclosure is shown, and the computer 1102 includes a processing unit 1104, a system memory 1106, and a system bus 1108. The system bus 1108 connects system components including (but not limited thereto) the system memory 1106 to the processing unit 1104. The processing unit 1104 may be any of a variety of commercially available processors. A dual processor and other multiprocessor architectures may also be used as the processing unit 1104.

The system bus 1108 may be any of several types of bus structures that may further be interconnected to a memory bus, a peripheral device bus, and a local bus using any of a variety of commercial bus architectures. The system memory 1106 includes a read only memory (ROM) 1110 and a random access memory (RAM) 1112. A basic input/output system (BIOS) is stored in a non-volatile memory 1110, such as a ROM, an EPROM, an EEPROM, etc., and the BIOS may include a basic routine that helps transmission of information between components within the computer 1102, such as during startup. The RAM 1112 may also include high-speed RAM, such as static RAM for caching data.

The computer 1102 may also include an internal hard disk drive (HDD) 1114 (for example, EIDE, SATA)—this internal hard disk drive 1114 may also be configured for external use within a suitable chassis (not shown)—, a magnetic floppy disk drive (FDD) 1116 (for example, for reading from or writing to removable diskette 1118), and an optical disk drive 1120 (for example, for reading from or writing to a CD-ROM disk 1122 or for reading from or writing to other high capacity optical media such as a DVD). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. The interface 1124 for implementing the external drive may include, for example, at least one or both of Universal Serial Bus (USB) and IEEE 1394 interface technologies.

These drives and their associated computer-readable media provide non-volatile storage of data, data structures, computer-executable instructions, and the like. In the case of the computer 1102, drives and media correspond to one that stores any data in a suitable digital format. Although the computer readable storage media are described based on HDDs, removable magnetic disks, and removable optical media such as CDs or DVDs, those skilled in the art will be appreciated that other computer-readable storage media such as zip drives, magnetic cassettes, flash memory cards, cartridges, and the like may also be used in the exemplary operating environment, and any such media may include computer-executable instructions for performing the methods of the present disclosure.

A number of program modules including operating systems 1130, one or more application programs 1132, other program modules 1134, and program data 1136 may be stored in the drive and the RAM 1112. All or portions of the operating systems, applications, modules, and/or data may also be cached in the RAM 1112. It will be appreciated that the present disclosure may be implemented in various commercially available operating systems or combinations of operating systems.

A user may input commands and information into the computer 1102 via one or more wired/wireless input devices, for example, a pointing device such as a keyboard 1138 and a mouse 1140. Other input devices (not shown) may include a microphone, an IR remote controller, a joystick, a game pad, a stylus pen, a touch screen, and the like. Although these and other input devices are often connected to the processing unit 1104 through the input device interface 1142 that is connected to the system bus 1108, parallel ports, IEEE 1394 serial ports, game ports, USB ports, IR interfaces, and the like may be connected by other interfaces.

A monitor 1144 or other type of display devices is also coupled to the system bus 1108 via an interface such as a video adapter 1146. In addition to the monitor 1144, the computer generally includes other peripheral output devices (not shown) such as speakers, printers, and the like.

The computer 1102 may operate in a networked environment using logical connections to one or more remote computers such as remote computer(s) 1148 via wired and/or wireless communications. The remote computer(s) 1148 may refer to workstations, server computers, routers, personal computers, portable computers, microprocessor-based entertainment devices, peer devices, or other common network nodes, and may generally include many or all of the components described with respect to the computer 1102, but only the memory storage device 1150 is shown for simplicity. The logical connections shown in the drawings include wired/wireless connections to a local area network (LAN) 1152 and/or a larger network, for example, a wide area network (WAN) 1154. Such LAN and WAN networking environments are common in offices and companies, and facilitate enterprise-wide computer networks, such as intranets, and all of which can be connected to a worldwide computer network, for example, the Internet.

When used in the LAN networking environment, the computer 1102 is connected to the local network 1152 through a wired and/or wireless communication network interface or an adapter 1156. The adapter 1156 may facilitate the wired or wireless communication to the LAN 1152, which also includes a wireless access point installed therein for communicating with a wireless adapter 1156. When used in a WAN networking environment, the computer 1102 may include a modem 1158, may be connected to a communication server on the WAN 1154, or may include other devices for establishing communications over the WAN 1154. A modem 1158, which may be an internal or external and wired or wireless device, is coupled to the system bus 1108 via the serial port interface 1142. In a networked environment, program modules described with respect to the computer 1102 or portions thereof may be stored in a remote memory/storage device 1150. It will be appreciated that the network connections shown in the drawings are exemplary and other devices for establishing a communication link between the computers may be used.

The computer 1102 may communicate with any wireless devices or entities that are operated through wireless communication, such as printers, scanners, desktop and/or portable computers, portable data assistants (PDAs), communication satellites, and any devices or place, and phones in association with wireless detectable tags. It may include at least Wi-Fi and Bluetooth wireless technologies. Accordingly, the communication may be a predefined structure as in a conventional network or may simply be an ad hoc communication between at least two devices.

Wi-Fi (Wireless Fidelity) makes it possible to connect to the Internet, etc. without a wire. The Wi-Fi refers to a wireless technology such as cell phones that allow these devices, for example, computers, to transmit and receive data indoors and outdoors, that is, anywhere within the coverage area of a base station. The Wi-Fi networks use a radio technology called IEEE 802.11 (a, b, g, etc.) to provide safe, reliable, and high-speed wireless connections. The Wi-Fi can be used to connect computers to each other, to the Internet, and to wired networks (using IEEE 802.3 or Ethernet). The Wi-Fi networks may operate in unlicensed 2.4 and 5 GHz radio bands, for example, at 11 Mbps (802.11a) or 54 Mbps (802.11b) data rates, or in products that include both bands (dual band).

A person having ordinary skill in the art of the present disclosure will recognize that various illustrative logical blocks, modules, processors, means, circuits and algorithm steps described in connection with the aspects disclosed herein may be implemented by electronic hardware (referred to as “software” for the purpose of convenience), various types of program, design codes, or a combination thereof. To clearly explain the interchangeability of hardware and software, various illustrative components, blocks, modules, circuits, and steps have been described above generally in terms of their functionality. Whether such functionality is implemented as hardware or software depends upon the specific application and design restrictions imposed on the overall system. A person skilled in the art of the present disclosure may implement the described functionality in various ways for each specific application, and such implementation decisions may not be interpreted as a departure from the scope of the present disclosure.

The various aspects presented herein may be implemented as methods, apparatuses, standard programming and/or articles of manufacture using engineering techniques. The term “article of manufacture” includes a computer program or media accessible from any computer-readable device. For example, the computer-readable storage medium includes magnetic storage devices (for example, hard disks, floppy disks, magnetic strips, etc.), optical disks (for example, CDs, DVDs, etc.), smart cards, and flash memory devices (for example, EEPROMs, cards, sticks, key drives, etc.), but it is not limited thereto. The term “machine-readable medium” includes wireless channels and various other media capable of storing, retaining, and/or transferring instruction(s) and/or data, but it is not limited thereto.

The description of the presented aspects is provided to enable any person skilled in the art to make or use the present disclosure. Various modifications to these aspects will be readily apparent to those skilled in the art, and the generic principles defined herein may be applied to other aspects without departing from the scope of the present disclosure. Thus, the present disclosure is not intended to be limited to the aspects presented herein, but is to be construed in the widest scope consistent with the principles and novel features presented herein.

What is claimed is:

1. A method for inferring an intent of a message performed by a computing device including at least one processor, the method comprising:
requesting chatbot application programming interface (API) connection information to a server upon receiving a request signal for inferring the intent of the message from a user terminal;
inferring the intent of the message by calling a chatbot API determined based on the chatbot API connection information when receiving the chatbot API connection information from the server; and
transmitting a result of inferring the intent of the message to the user terminal.

2. The method of claim 1, wherein inferring the intent of the message by calling the chatbot API determined based on the chatbot API connection information includes:
recognizing an entity name from the message by performing pre-processing on the message included in the request signal; and
inferring the intent of the message by using a pre-trained intent inference model having the entity name as an input value.

3. The method of claim 2, wherein recognizing the entity name from the message includes recognizing the entity name from the message according to a named entity recognition (NER) technique for recognizing the entity name from an unstructured text included in the message.

4. The method of claim 2, wherein the pre-trained intent inference model is trained using training data transformed from the unstructured text using the NER technique.

5. The method of claim 1, wherein the chatbot API connection information includes at least one of an Internet protocol (IP) address, host address, or port information.

6. The method of claim 1, wherein the chatbot API includes:
a first chatbot API; and
a second chatbot API that is further created based on a number of request signals for inferring the intent of the message.

7. The method of claim 1, further comprising:
receiving status information indicating a status of at least one chatbot API among a plurality of chatbot APIs from the server; and
removing the at least one chatbot API based on the status information

8. A computing device comprising:
a communication unit configured to request chatbot application programming interface (API) connection information to a server upon receiving a request signal for inferring an intent of a message from a user terminal; and
a processor configured to infer the intent of the message by calling a chatbot API determined based on the chatbot API connection information when receiving the chatbot API connection information from the server,
wherein the communication unit transmits a result of inferring the intent of the message to the user terminal.

9. A computer program stored in a computer-readable storage medium, wherein the computer program is configured to perform a method for inferring an intent of a message when executed by at least one processor, and the method comprises:
requesting chatbot application programming interface (API) connection information to a server upon receiving a request signal for inferring the intent of the message from a user terminal;
inferring the intent of the message by calling a chatbot API determined based on the chatbot API connection information when receiving the chatbot API connection information from the server; and
transmitting a result of inferring the intent of the message to the user terminal.

10. A method for inferring an intent of a message performed by a server including at least one processor, the method comprising:
inferring the intent of the message by calling a chatbot application programming interface (API) determined based on chatbot API connection information upon receiving a request signal for inferring the intent of the message from a user terminal; and
transmitting a result of inferring the intent of the message to the user terminal.

11. A server comprising:
a server storage unit configured to store chatbot application programming interface (API) connection information;
a server communication unit configured to receive a request signal for inferring an intent of a message from a user terminal; and
a server processor configured to infer the intent of the message by calling a chatbot API determined based on the chatbot API connection information stored in the storage unit upon receiving the request signal for inferring the intent of the message from the server,
wherein the server communication unit transmits a result of inferring the intent of the message to the user terminal.

12. A computer program stored in a computer-readable storage medium, wherein the computer program is configured to perform a method for inferring an intent of a message when executed by at least one server processor, and the method comprises:
inferring the intent of the message by calling a chatbot application programming interface (API) determined based on chatbot API connection information upon receiving a request signal for inferring the intent of the message from a user server; and
transmitting a result of inferring the intent of the message to the user terminal.
